(19) United States
(12) Patent Application Publication
(10) Pub. No.: US 2007/0189151 A1
(43) Pub. Date: Aug. 16, 2007

(54) METHOD AND APPARATUS FOR PERFORMING UPLINK TRANSMISSION IN A MULTIPLE-INPUT MULTIPLE-OUTPUT SINGLE CARRIER FREQUENCY DIVISION MULTIPLE ACCESS SYSTEM

(75) Inventors: Jung-Lin Pan, Selden, NY (US); Donald M. Grieco, Manhassett, NY (US); Robert Lind Olesen, Huntington, NY (US); Yingxue Li, Exton, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/627,706

(22) Filed: Jan. 26, 2007

Related U.S. Application Data
(60) Provisional application No. 60/772,462, filed on Feb. 10, 2006.
(60) Provisional application No. 60/783,640, filed on Mar. 17, 2006.

(51) Int. Cl. H04J 11/00

(52) U.S. Cl. 370/210; 370/204

(57) ABSTRACT

A method and apparatus for performing uplink transmission in a multiple-input multiple-output (MIMO) single carrier frequency division multiple access (SC-FDMA) system are disclosed. At a wireless transmit/receive unit (WTRU), input data is encoded and parsed into a plurality of data streams. After modulation and Fourier transform, one of transmit beamforming, space time coding (STC) and spatial multiplexing is selectively performed based on channel state information. Symbols are then mapped to subcarriers and transmitted via antennas. The STC may be space frequency block coding (SFBC) or space time block coding (STBC). Per antenna rate control may be performed on each data stream based on the channel state information. At a Node-B, MIMO decoding may be performed based on one of minimum mean square error (MMSE) decoding, MMSE-successive interference cancellation (SIC) decoding and maximum likelihood (ML) decoding. Space time decoding may be performed if STC is performed at the WTRU.

### CROSS REFERENCE TO RELATED APPLICATIONS

This application claims the benefit of U.S. Provisional Application Nos. 60/772,462 filed Feb. 10, 2006 and 60/783,640 filed Mar. 17, 2006, which are incorporated by reference as if fully set forth.

### FIELD OF INVENTION

The present invention is related to wireless communication systems. More particularly, the present invention is related to a method and apparatus for performing uplink transmission in a multiple-input multiple-output (MIMO) single carrier frequency division multiple access (SC-FDMA) system.

### BACKGROUND

Developers of third generation (3G) wireless communication systems are considering long term evolution (LTE) of the 3G systems to develop a new radio access network for providing a high-data-rate, low-latency, packet-optimized, improved system with higher capacity and better coverage. In order to achieve these goals, instead of using code division multiple access (CDMA), which is currently used in the 3G systems, SC-FDMA is proposed as an air interface for performing uplink transmission in LTE.

The basic uplink transmission scheme in LTE is based on a low peak-to-average power ratio (PAPR) SC-FDMA transmission with a cyclic prefix (CP) to achieve uplink inter-user orthogonality and to enable efficient frequency-domain equalization at the receiver side. Both localized and distributed transmission may be used to support both frequency-adaptive and frequency-diversity transmission.

FIG. 1 shows a conventional sub-frame structure for performing uplink transmission as proposed in LTE. The sub-frame includes six long blocks (LBs) 1-6 and two short blocks (SBs) 1 and 2. The SBs 1 and 2 are used for reference signals, (i.e., pilots), for coherent demodulation and/or control or data transmission. The LBs 1-6 are used for control and/or data transmission. A minimum uplink transmission time interval (TTI) is equal to the duration of the sub-frame. It is possible to concatenate multiple sub-frames or timeslots into longer uplink TTI.

MIMO refers to the type of wireless transmission and reception scheme where both a transmitter and a receiver employ more than one antenna. A MIMO system takes advantage of the spatial diversity or spatial multiplexing (SM) to improve the signal-to-noise ratio (SNR) and increases throughput. MIMO has many benefits including improved spectrum efficiency, improved bit rate and robustness at the cell edge, reduced inter-cell and intra-cell interference, improvement in system capacity and reduced average transmit power requirements.

### SUMMARY

The present invention is related to a method and apparatus for performing uplink transmission in a MIMO SC-FDMA system. At a wireless transmit/receive unit (WTRU), input data is encoded and parsed into a plurality of data streams. After a modulation and Fourier transform is implemented, one of transmit beamforming, pre-coding, space time coding (STC) and SM is selectively performed based on channel state information. Symbols are then mapped to subcarriers and transmitted via a plurality of antennas. The STC may be space frequency block coding (SFBC) or space time block coding (STBC). Per antenna rate control may be performed on each data stream based on the channel state information. At a Node-B, MIMO decoding may be performed based on minimum mean square error (MMSE) decoding, MMSE-successive interference cancellation (SIC) decoding, maximum likelihood (ML) decoding, or similar advanced receiver techniques for MIMO. Space time decoding may be performed if STC is performed at the WTRU.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional sub-frame format proposed for SC-FDMA in LTE;

FIG. 2 is a block diagram of a WTRU configured in accordance with the present invention;

FIG. 3 shows transmit processing labels in accordance with the present invention;

FIG. 4 is a block diagram of a Node-B configured in accordance with the present invention;

FIG. 5 is a block diagram of a WTRU configured in accordance with another embodiment of the present invention; and

FIG. 6 is a block diagram of a Node-B configured in accordance with another embodiment of the present invention.

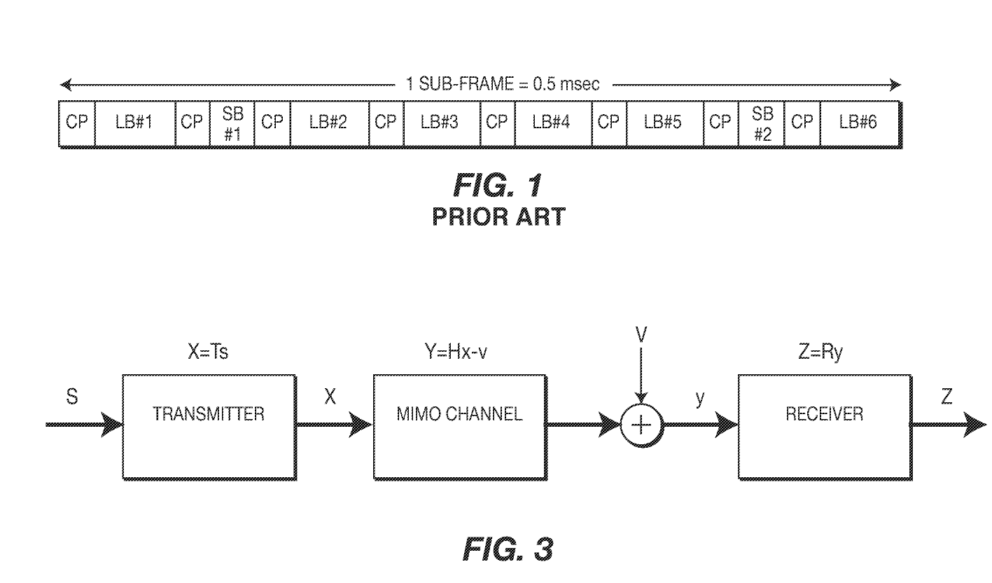

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, a cellular telephone, a personal data assistance (PDA), a computer, or any other type of user device capable of operating in a wireless environment. When referred to hereafter, the terminology “Node-B” includes but is not limited to a base station, a site controller, an access point (AP) or any other type of interfacing device in a wireless environment.

The features of the present invention may be incorporated into an integrated circuit (IC) or be configured in a circuit comprising a multitude of interconnecting components.

The present invention provides methods for selectively implementing STC, SM, or transmit beamforming for uplink transmission in a MIMO SC-FDMA system. For STC, any form of STC may be used including STBC, SFBC, quasi-orthogonal Alamouti for four (4) transmit antennas, time reversed STBC (TR-STBC), cyclic delay diversity (CDD), or the like. Hereinafter, the present invention will be explained with reference to STBC and SFBC as representative examples for STC schemes. SFBC has a higher resilience to channels that have high time selectivity and low frequency selectivity, while STBC may be used if the time selectivity is low. Because the advantages of STC versus transmit beamforming are dependent on channel conditions, (e.g., a signal-to-noise ratio (SNR)), the mode of transmission, (STC vs. transmit beamforming), is selected based on a suitable channel metric.

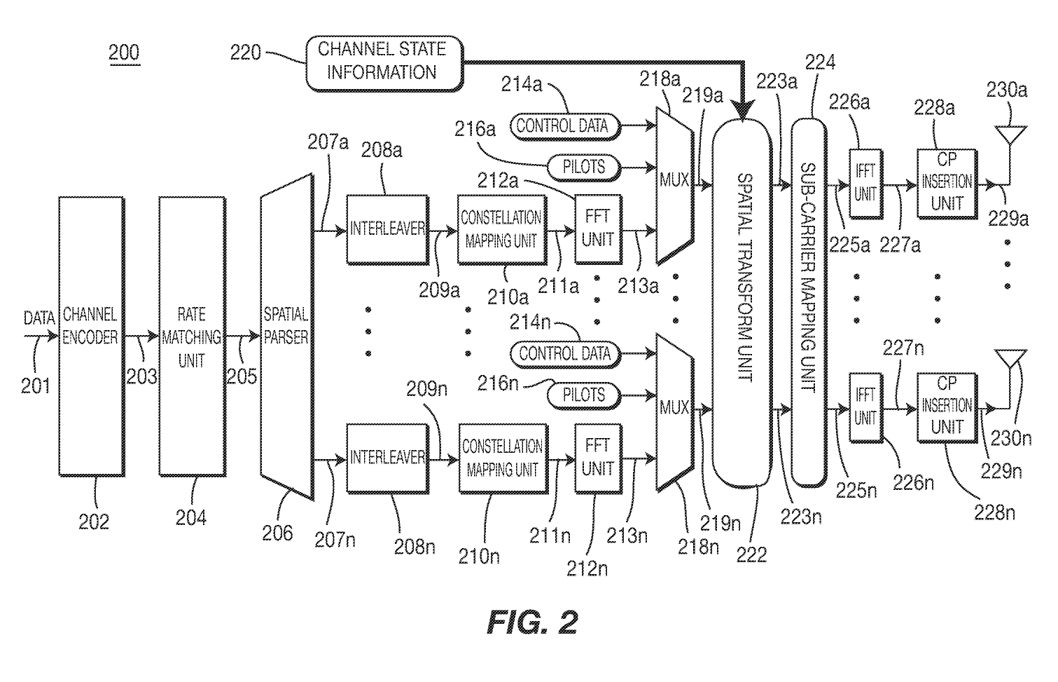

FIG. 2 is a block diagram of a WTRU 200 configured in accordance with the present invention. The WTRU 200 includes a channel encoder 202, a rate matching unit 204, a spatial parser 206, a plurality of interleavers 208a-208n, a plurality of constellation mapping units 210a-201n, a plurality of fast Fourier transform (FFT) units 212a-212n, a plurality of multiplexers 218a-218n, a spatial transform unit 222, a subcarrier mapping unit 224, a plurality of inverse fast Fourier transform (IFFT) units 226a-226n, a plurality of CP insertion units 228a-228n and a plurality of antennas 230a-230n. It should be noted that the configuration of the WTRUs 200, 500 and Node-Bs 400, 600 in FIGS. 2, and 4-6 are provided as an example, not as a limitation, and the processing may be performed by more or less components and the order of processing may be switched.

The channel encoder 202 encodes input data 201. Adaptive modulation and coding (AMC) is used where any coding rate, and any coding scheme may be used. For example, the coding rate may be ½, ⅓, ⅕, ¾, ⅚, 8/9 or the like. The coding scheme may be Turbo coding, convolutional coding, block coding, low density parity check (LDPC) coding, or the like. The encoded data 203 may be punctured by the rate matching unit 204. Alternatively, multiple input data streams may be encoded and punctured by multiple channel encoders and rate matching units.

The encoded data after rate matching 205 is parsed into a plurality of data streams 207a-207n by the spatial parser 206. Data bits on each data stream 207a-207n are preferably interleaved by the interleavers 208a-208n. The data bits after interleaving 209a-209n are then mapped to symbols 211a-211n by the constellation mapping units 210a-210n in accordance with a selected modulation scheme. The modulation scheme may be binary phase shift keying (BPSK), Quadrature phase shift keying (QPSK), 8 phase shift keying (8PSK), 16 Quadrature amplitude modulation (QAM), 64 QAM, or similar modulation schemes. Symbols 211a-211n on each data stream are processed by the FFT units 212a-212n which outputs frequency domain data 213a-213n. Control data 214a-214n and/or pilots 216a-216n are multiplexed with the frequency domain data 213a-213n by the multiplexer 218a-218n. The frequency domain data 219a-219n (including the multiplexed control data 214a-214n and/or pilots 216a-216n) are processed by the spatial transform unit 222.

The spatial transform unit 222 selectively performs one of transmit beamforming, pre-coding, STC, SM, or any combination thereof on the frequency domain data 213a-213n based on channel state information 220. The channel state information 220 may contain channel impulse response or pre-coding matrix and may also contain at least one of a signal-to-noise ratio (SNR), a WTRU speed, a channel matrix rank, a channel condition number, delay spread, or short and/or long term channel statistics. The condition number is related to the rank of the channel. An ill-conditioned channel may be rank deficient. A low rank or ill-conditioned channel would exhibit better robustness using a diversity scheme, such as STBC, since the channel would not have sufficient degree of freedom to support SM with transmit beamforming. A high rank channel would support higher data rates using SM with transmit beamforming. At low WTRU speed close-loop pre-coding or transmit beamforming may be selected while at high WTRU speed open-loop SM or transmit diversity scheme, (such as STC), may be chosen. When an SNR is high, close-loop transmit beamforming may be selected while at a low SNR transmit diversity scheme may be preferred. The channel state information 220 may be obtained from a Node-B using conventional techniques, such as direct channel feedback (DCFB).

The transmit beamforming may be performed using a channel matrix decomposition method, (e.g., singular value decomposition (SVD)), a codebook and index-based precoding method, an SM method, or the like. For example, in pre-coding or transmit beamforming using SVD, a channel matrix is estimated and decomposed using SVD and the resulting right singular vectors or the quantized right singular vectors are used for the pre-coding matrix or beamforming vectors. In pre-coding or transmit beamforming using codebook and index-based method, a pre-coding matrix in a codebook that has the highest SNR is selected and the index to this pre-coding matrix is fed back. Metrics other than SNR may be used as selection criterion such as mean square error (MSE), channel capacity, bit error rate (BER), block error rate (BLER), throughput, or the like, In SM, the identity matrix is used as a pre-coding matrix, (i.e., there is actually no pre-coding weight applied to antennas for SM). SM is supported by the transmit beamforming architecture transparently (simply no-feedback of precoding matrix or beamforming vectors needed). The transmit beamforming scheme approaches the Shannon bound at a high SNR for a low complexity MMSE detector. Because of transmit processing at the WTRU 200, the transmit beamforming minimizes the required transmit power at the expense of a small additional feedback.

The symbol streams 223a-223n processed by the spatial transform unit 222 are then mapped to subcarriers by the subcarrier mapping unit 224. The subcarrier mapping may be either distributed subcarrier mapping or localized subcarrier mapping. The subcarrier mapped data 225a-225n is then processed by the IFFT units 226a-226n which output time domain data 227a-227n. A CP is added to the time domain data 227a-227n by the CP insertion unit 228a-228n. The time domain data with CP 229a-229n is then transmitted via antennas 230a-230n.

The WTRU 200 supports both a single stream with a single codeword, (e.g., for SFBC), and one or more streams or codewords with transmit beamforming. Codewords can be seen as data streams that are independently channel-coded with independent cyclic redundancy check (CRC). Different codewords may use the same time-frequency-code resource.

FIG. 3 shows transmit processing labels in accordance with the present invention. For transmit beamforming, a channel matrix is decomposed using a singular value decomposition (SVD) or equivalent method as follows:
H=UDV^{H}. Equation (1)

The spatial transform for SM or transmit beamforming may be expressed as follows:
x=Ts; Equation (2)
where the matrix T is a generalized transform matrix. In the case that transmit beamforming is used, the transform matrix T is chosen to be a beamforming matrix V which is obtained from the SVD operation above, (i.e., T=V).

If STC, (i.e., SFBC or STBC), is used, the encoded data for SFBC or STBC may be expressed as follows:

$$[ \begin{matrix}{d}_{2 n} & {d}_{2 n + 1} \\ - {d}_{2 n + 1}^{*} & {d}_{2 n}^{*}\end{matrix} ] ;$$

where the first and second row of the above matrix represents the encoded data for antennas 1 and 2, respectively, after SFBC or STBC encoding using Alamouti scheme. When SFBC is used, d₂ₙ and d₂ₙ₊₁ represent the data symbols of the subcarriers 2n and 2n+1 for a pair of subcarriers. When STBC is used, d₂ₙ and d₂ₙ₊₁ represent two adjacent OFDM symbols 2n and 2n+1. Both schemes have the same effective code rate.

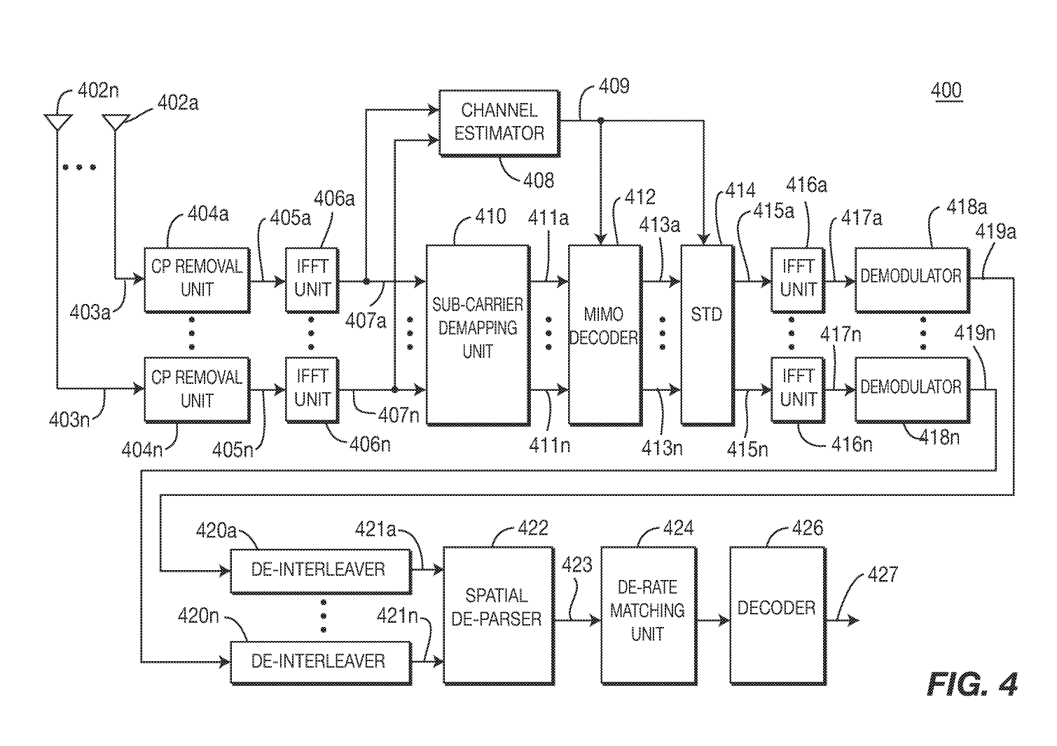

FIG. 4 is a block diagram of a Node-B 400 configured in accordance with the present invention. The Node-B 400 comprises a plurality of antennas 402a-402n, a plurality of CP removal units 404a-404n, a plurality of FFT units 406a-406n, a channel estimator 408, a subcarrier de-mapping unit 410, a MIMO decoder 412, a spatial time decoder (STD) 414, a plurality of IFFT units 416a-416n, a plurality of demodulators 418a-418n, a plurality of de-interleavers 420a-420n, a spatial de-parser 422, a de-rate matching unit 424, and a decoder 426.

The CP removal units 404a-404n remove a CP from each of the received data streams 403a-403n from each of the receive antennas 402a-402n. The received data streams after CP removal 405a-405n are converted to frequency domain data 407a-407n by the FFT units 406a-406n. The channel estimator 408 generates a channel estimate 409 from the frequency domain data 407a-407n using conventional methods. The channel estimation is performed on a per sub-carrier basis. The subcarrier de-mapping unit 410 performs the opposite operation which is performed at the WTRU 200 of FIG. 2. The subcarrier de-mapped data 411a-411n is then processed by the MIMO decoder 412.

The MIMO decoder 412 may be a minimum mean square error (MMSE) decoder, an MMSE-successive interference cancellation (SIC) decoder, a maximum likelihood (ML) decoder, or a decoder using any other advanced techniques for MIMO. MIMO decoding using a linear MMSE (LMMSE) decoder may be expressed as follows:
R=Rₛₛ\tilde{H}^{H}(\tilde{H}Rₛₛ\tilde{H}^{H}+Rᵥᵥ)⁻¹; Equation (3)
where R is a receive processing matrix, Rₛₛ and Rᵥᵥ are correlation matrices and \tilde{H} is an effective channel matrix which includes the effect of the V matrix on the estimated channel response.

The STD 414 decodes the STC if STC has been used at the WTRU 200. SFBC or STBC decoding with MMSE may be expressed as follows:
R=(H^{H}Rᵥᵥ⁻¹H+Rₛₛ⁻¹)⁻¹H^{H}Rᵥᵥ⁻¹; Equation (4)
where H is the estimated channel matrix.

$$H = [ \begin{matrix}{h}_{11} & - {h}_{12} \\ {h}_{21} & - {h}_{22} \\ {h}_{12}^{*} & {h}_{11}^{*} \\ {h}_{22}^{*} & {h}_{21}^{*}\end{matrix} ] .$$

The channel coefficients hᵢⱼ in the channel matrix H is the channel response corresponding to transmit antenna j and receiving antenna i.

STC is advantageous over transmit beamforming at a low SNR. In particular, the simulation results demonstrate the advantage of using STC at a low SNR over transmit beamforming. STC does not require channel state information feedback, and is simple to implement. STBC is robust against channels that have high frequency selectivity while SFBC is robust against channels that have high time selectivity. SFBC may be decodable in a single symbol and may be advantageous when low latency is required, (e.g., voice over IP (VoIP)). Under qausi-static conditions both SFBC and STBC provide similar performance.

After MIMO decoding (if STC is not used) or after space time decoding (if STC is used), the decoded data 413a-413n or 415a-415n is processed by the IFFT units 416a-416n for conversion to time domain data 417a-417n. The time domain data 417a-417n is processed by the demodulators 418a-418n to generate bit streams 419a-419n. The bit streams 419a-419n are processed by the de-interleavers 420a-420n, which is an opposite operation of the interleavers 208a-208n of the WTRU 200 of FIG. 2. The de-interleaved bit streams 421a-421n are merged by the spatial de-parser 422. The merged bit stream 423 is then processed by the de-rate matching unit 424 and decoder 426 to recover the data 427.

Transmit beamforming at the WTRU 200 requires CSI for computing a precoding matrix V. The Node-B 400, 600 includes a channel state feedback unit (not shown) to send the channel state information to the WTRU. The feedback requirements for multiple antennas grow with the product of the number of transmit antennas and receive antennas as well as the delay spread, while capacity only grows linearly. Therefore, in order to reduce feedback requirements, a limited feedback may be used. The most straight forward method for limited feedback is channel vector quantization (VQ). A vectorized codebook may be constructed using an interpolation method. The computation of the V matrix requires eigen-decomposition. In a matrix-based precoding method, feedback or quantization may be used. In the matrix-based precoding method, the best precoding matrix in a codebook is selected and an index to the selected precoding matrix is fed back. The best precoding matrix is determined based on predetermined selection criteria such as the largest SNR, the highest correlation or any other appropriate metrics. In order to reduce computational requirements of the WTRU, a quantized preceding may be used.

Whether the eigen-decomposition required for obtaining the V matrix is performed either at the WTRU 200, Node-B 400, or both, information regarding the CSI is still needed at the WTRU 200. If the eigen-decomposition is performed at the Node-B 400, the CSI may be used at the WTRU 200 to further improve the estimate of the transmit precoding matrix at the WTRU 200.

A robust feedback of the spatial channel may be obtained by averaging across frequency. This method may is referred to as statistical feedback. Statistical feedback may be either mean feedback or covariance feedback. Since covariance information is averaging across the subcarriers, the feedback parameters for all subcarriers are the same, while mean feedback must be done for each individual subcarrier or group of subcarriers. Consequently, the latter requires more signaling overhead. Since the channel exhibits statistical reciprocity for covariance feedback, implicit feedback may be used for transmit beamforming from the WTRU 200. Covariance feedback is also less sensitive to feedback delay as compared to per-subcarrier mean feedback.

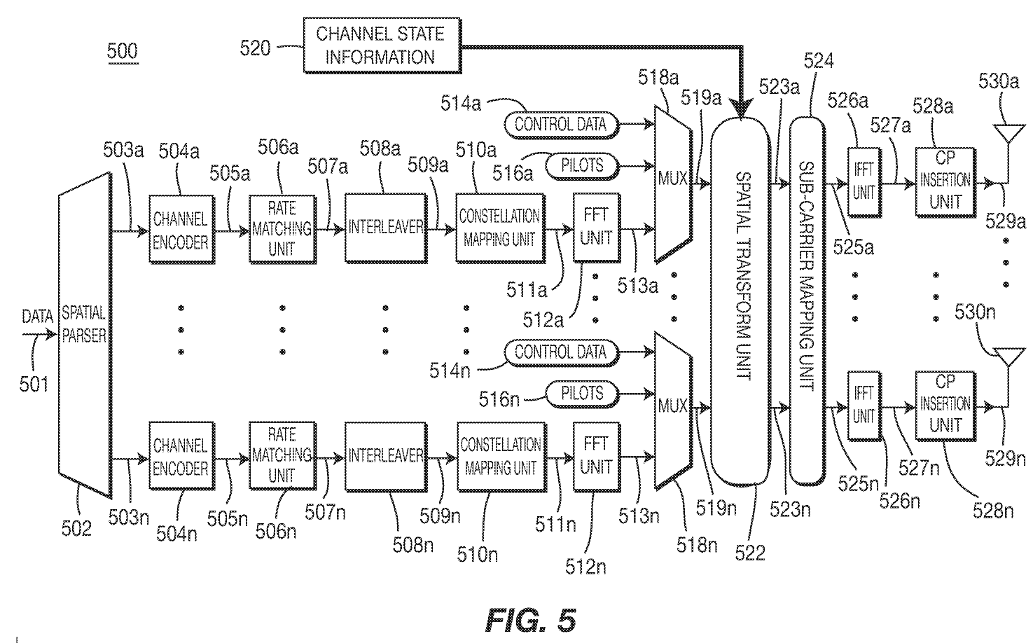

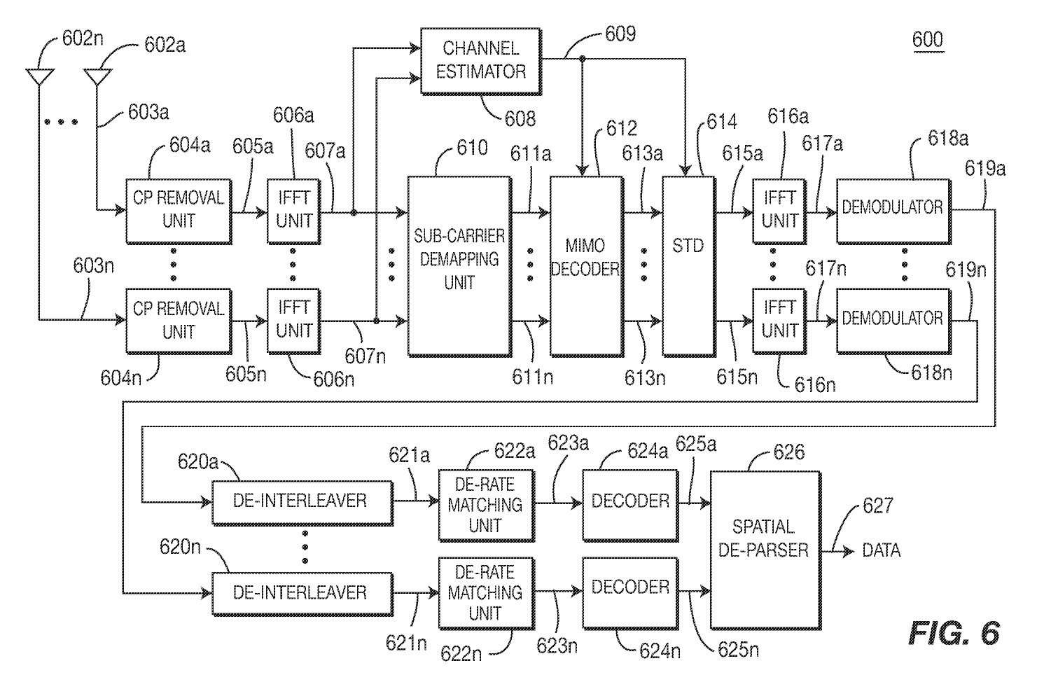

FIGS. 5 and 6 are block diagrams of a WTRU 500 and a Node-B 600 configured in accordance with another embodiment of the present invention. The WTRU 500 and Node-B 600 implement per antenna rate control (PARC) with or without transmit beamforming, precoding or SM.

The WTRU 500 includes a spatial parser 502, a plurality of channel encoders 504a-504n, a plurality of rate matching units 506a-506n, a plurality of interleavers 508a-508n, a plurality of constellation mapping units 510a-501n, a plurality of FFT units 512a-512n, a plurality of multiplexers 518a-518n, a spatial transform unit 522, a subcarrier mapping unit 524, a plurality of IFFT units 526a-526n, a plurality of CP insertion units 528a-528n and a plurality of antennas 530a-530n. It should be noted that the configuration of the WTRU 500 is provided as an example, not as a limitation, and the processing may be performed by more or less components and the order of processing may be switched.

Transmit data 501 is first demultiplexed into a plurality of data streams 503a-503n by the spatial parser 502. Adaptive modulation and coding (AMC) may be used for each of the data streams 503a-503n. Bits on each of the data streams 503a-503n are then encoded by each of the channel encoders 504a-504n and punctured for rate matching by each of the rate matching units 506a-506n. Alternatively, multiple input data streams may be encoded and punctured by the channel encoders and rate matching units, rather than parsing one transmit data into multiple data streams.

The encoded data after rate matching 507a-507n is preferably interleaved by the interleavers 508a-508n. The data bits after interleaving 509a-509n are then mapped to symbols 511a-511n by the constellation mapping units 510a-510n in accordance with a selected modulation scheme. The modulation scheme may be BPSK, QPSK, 8PSK, 16QAM, 64 QAM, or similar modulation schemes. Symbols 511a-511n on each data stream are processed by the FFT units 512a-512n which outputs frequency domain data 513a-513n. Control data 514a-514n and/or pilots 516a-516n are multiplexed with the frequency domain data 513a-513n by the multiplexers 518a-518n. The frequency domain data 519a-519n (including the multiplexed control data 514a-514n and/or pilots 516a-516n) are processed by the spatial transform unit 522.

The spatial transform unit 522 selectively performs one of transmit beamforming, pre-coding, STC, SM, or any combination thereof on the frequency domain data 513a-513n based on channel state information 520. The channel state information 520 may contain channel impulse response or pre-coding matrix and may also contain at least one of an SNR, a WTRU speed, a channel matrix rank, a channel condition number, delay spread, or short and/or long term channel statistics. The channel state information 520 may be obtained from a Node-B using conventional techniques, such as DCFB.

The transmit beamforming may be performed using a channel matrix decomposition method, (e.g., SVD), a codebook and index-based precoding method, an SM method, or the like. For example, in pre-coding or transmit beamforming using SVD, a channel matrix is estimated and decomposed using SVD and the resulting right singular vectors or the quantized right singular vectors are used for the pre-coding matrix or beamforming vectors. In pre-coding or transmit beamforming using codebook and index-based method, a pre-coding matrix in a codebook that has the highest SNR is selected and the index to this pre-coding matrix is fed back. Metrics other than SNR may be used as selection criterion such as MSE, channel capacity, BER, BLER, throughput, or the like, In SM, the identity matrix is used as a pre-coding matrix, (i.e., there is actually no pre-coding weight applied to antennas for SM). SM is supported by the transmit beamforming architecture transparently (simply no-feedback of precoding matrix or beamforming vectors needed). The transmit beamforming scheme approaches the Shannon bound at a high SNR for a low complexity MMSE detector. Because of transmit processing at the WTRU 500, the transmit beamforming minimizes the required transmit power at the expense of a small additional feedback.

The symbol streams 523a-523n processed by the spatial transform unit 522 are then mapped to subcarriers by the subcarrier mapping unit 524. The subcarrier mapping may be either distributed subcarrier mapping or localized subcarrier mapping. The subcarrier mapped data 525a-525n is then processed by the IFFT units 526a-526n which output time domain data 527a-527n. A CP is added to each of the time domain data 527a-527n by the CP insertion units 528a-528n. The time domain data with CP 529a-529n is then transmitted via a plurality of antennas 530a-530n.

The Node-B 600 includes a plurality of antennas 602a-602n, a plurality of CP removal units 604a-604n, a plurality of FFT units 606a-606n, a channel estimator 608, a subcarrier de-mapping unit 610, a MIMO decoder 612, an STD 614, a plurality of IFFT units 616a-616n, a plurality of demodulators 618a-618n, a plurality of de-interleavers 620a-620n, a plurality of de-rate matching units 622a-622n, a plurality of decoders 624a-624n and a spatial de-parser 626.

The CP removal units 604a-604n remove a CP from each of the received data streams 603a-603n from each of the receive antennas 602a-602n. The received data streams after CP removal 605a-605n are converted to frequency domain data 607a-607n by the FFT units 606a-606n. The channel estimator 608 generates a channel estimate 609 from the frequency domain data 607a-607n using conventional methods. The channel estimation is performed on a per sub-carrier basis. The subcarrier de-mapping unit 610 performs the opposite operation which is performed at the WTRU 500 of FIG. 5. The subcarrier de-mapped data 611a-611n is then processed by the MIMO decoder 612.

The MIMO decoder 612 may be an MMSE decoder, an MMSE-SIC decoder, an ML decoder, or a decoder using any other advanced techniques for MIMO. The STD 614 decodes the STC if STC has been used at the WTRU 500.

After MIMO decoding (if STC is not used) or after space time decoding (if STC is used), the decoded data 613a-613n or 615a-615n is processed by the IFFT units 616a-616n for conversion to time domain data 617a-617n. The time domain data 617a-617n is processed by the demodulators 618a-618n to generate bit streams 619a-619n. The bit streams 619a-619n are processed by the de-interleavers 620a-620n, which is an opposite operation of the interleavers 508a-508n of the WTRU 500 of FIG. 5. Each of the de-interleaved bit streams 621a-621n is then processed by each of the de-rate matching units 624a-624n. The de-rate matched bit streams 623a-623n are decoded by the decoders 624a-624n. The decoded bits 625a-625n are merged by the spatial de-parser 626 to recover data 627.

Although the features and elements of the present invention are described in the preferred embodiments in particular combinations and for particular frame, subframe or timeslot format, each feature or element can be used alone without the other features and elements of the preferred embodiments or in various combinations with or without other features and elements of the present invention and can be used for other frame, subframe and timeslot formats. The methods provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any integrated circuit, and/or a state machine.

A processor in association with software may be used to implement a radio frequency transceiver for use in a WTRU, user equipment, terminal, base station, radio network controller, or any host computer. The WTRU may be used in conjunction with modules, implemented in hardware and/or software, such as a camera, a videocamera module, a videophone, a speakerphone, a vibration device, a speaker, a microphone, a television transceiver, a handsfree headset, a keyboard, a Bluetooth module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for performing uplink transmission in a wireless communication system, the method comprising:
generating a plurality of encoded data streams;
generating a symbol sequence from each encoded data stream in accordance with a selected modulation scheme;
performing a Fourier transform on each symbol sequence to generate frequency domain data;
selectively performing one of transmit beamforming, preceding, space time coding (STC) and spatial multiplexing on the frequency domain data based on channel state information;
mapping symbols on each symbol sequence to subcarriers;
performing inverse Fourier transform on the subcarrier mapped data on each symbol sequence to generate time domain data; and
transmitting the time domain data.

2. The method of claim 1 wherein the STC is one of space frequency block coding (SFBC), space time block coding (STBC), quasi-orthogonal Alamouti coding, time reversed STBC (TR-STBC) and cyclic delay diversity (CDD).

3. The method of claim 1 wherein the channel state information is at least one of channel impulse response, a precoding matrix, a signal-to-noise ratio (SNR), a channel matrix rank, a channel condition number, delay spread, a wireless transmit/receive unit (WTRU) speed and channel statistics.

4. The method of claim 1 further comprising:
puncturing on each of the encoded data streams for rate matching.

5. The method of claim 1 further comprising:
interleaving bits on each of the encoded data streams.

6. The method of claim 1 wherein a per antenna rate control is performed on the encoded data streams based on the channel state information.

7. The method of claim 1 wherein the transmit beamforming is a transmit eigen-beamforming using channel matrix decomposition.

8. The method of claim 1 wherein the transmit beamforming is performed using codebook and index-based precoding.

9. The method of claim 1 wherein the transmit beamforming is performed using steering vector-based beamforming.

10. The method of claim 1 further comprising:
multiplexing control data and pilots with the frequency domain data.

11. The method of claim 1 wherein the wireless communication system is a multiple-input multiple output (MIMO) single carrier frequency division multiple access (SC-FDMA) system.

12. The method of claim 1 further comprising:
receiving the time domain data;
performing Fourier transform on the received time domain data to generate received frequency domain data;
performing subcarrier de-mapping;
generating channel estimate;
performing decoding on the received subcarrier de-mapped data based on the channel estimate;
performing an inverse Fourier transform on the decoded received subcarrier de-mapped data; and
performing demodulation and decoding.

13. The method of claim 12 wherein the decoding is performed based on one of minimum mean square error (MMSE) decoding, MMSE-successive interference cancellation (SIC) decoding and maximum likelihood (ML) decoding.

14. The method of claim 12 further comprising:
performing space time decoding if space time coding is performed for transmission.

15. The method of claim 1 wherein the channel state information is fed back from a communication peer.

16. The method of claim 15 wherein a limited feedback is used for channel state information feedback.

17. The method of claim 16 wherein channel vector quantization (VQ) is used for channel state information feedback.

18. The method of claim 15 wherein eigen-decomposition of a channel matrix is performed at the communication peer to feedback a V matrix.

19. The method of claim 15 wherein statistical feedback is used for channel state information feedback.

20. The method of claim 19 wherein one of mean feedback and covariance feedback is used for channel state information feedback.

21. In a multiple-input multiple output (MIMO) single carrier frequency division multiple access (SC-FDMA) wireless communication system, a wireless transmit/receive unit (WTRU) for performing uplink transmission, the WTRU comprising:
an encoder for encoding input data;
a constellation mapping unit for generating a symbol sequence from each encoded data stream in accordance with a selected modulation scheme;
a Fourier transform unit for performing a Fourier transform on each symbol sequence to generate frequency domain data;
a spatial transform unit for selectively performing one of transmit beamforming, preceding, space time coding (STC) and spatial multiplexing on the frequency domain data based on channel state information;
a subcarrier mapping unit for mapping output of the spatial transform unit to subcarriers;
an inverse Fourier transform unit for performing inverse Fourier transform on the subcarrier mapped data to generate time domain data; and
a plurality of antennas for transmitting the time domain data.

22. The WTRU of claim 21 wherein the spatial transform unit is configured to perform at least one of space frequency block coding (SFBC), space time block coding (STBC), quasi-orthogonal Alamouti coding, time reversed STBC (TR-STBC) and cyclic delay diversity (CDD).

23. The WTRU of claim 21 wherein the channel state information is at least one of channel impulse response, a precoding matrix, a signal-to-noise ratio (SNR), a channel matrix rank, a channel condition number, delay spread, a wireless transmit/receive unit (WTRU) speed and channel statistics.

24. The WTRU of claim 21 further comprising:
a spatial parser for generating a plurality of encoded data streams from the encoded input data.

25. The WTRU of claim 21 further comprising:
a spatial parser for generating a plurality of input data streams, each input data stream being encoded by the encoder.

26. The WTRU of claim 21 further comprising:
a rate matching unit for puncturing on each of the encoded data streams for rate matching.

27. The WTRU of claim 21 further comprising:
an interleaver for interleaving bits on each of the encoded data streams.

28. The WTRU of claim 21 wherein the spatial transform unit is configured to perform a per antenna rate control on the encoded data streams based on the channel state information.

29. The WTRU of claim 21 wherein the spatial transform unit is configured to perform the transmit beamforming using channel matrix decomposition.

30. The WTRU of claim 21 wherein the spatial transform unit is configured to perform the transmit beamforming using codebook and index based precoding.

31. The WTRU of claim 21 wherein the spatial transform unit is configured to perform the transmit beamforming using steering vector based beamforming.

32. The WTRU of claim 21 further comprising:
a multiplexer for multiplexing control data and pilots with the frequency domain data.

33. The WTRU of claim 21 wherein the channel state information is obtained from the Node-B.

34. In a multiple-input multiple output (MIMO) single carrier frequency division multiple access (SC-FDMA) wireless communication system, a Node-B for supporting uplink transmission, the Node-B comprising:
a plurality of antennas for receiving data;
a Fourier transform unit for performing a Fourier transform on the received data to generate frequency domain data;
a subcarrier de-mapping unit for performing subcarrier de-mapping on the frequency domain data;
a channel estimator for generating channel estimate;
a MIMO decoder for performing MIMO decoding on the frequency domain data after subcarrier de-mapping data based on the channel estimate;
an inverse Fourier transform unit for performing an inverse Fourier transform on an output from the MIMO decoder to generate time domain data;
a de-modulator for performing demodulation on the time domain data to generate demodulated data; and
a decoder for decoding the demodulated data.

35. The Node-B of claim 34 wherein the MIMO decoder is configured to perform the MIMO decoding based on one of minimum mean square error (MMSE) decoding, MMSE-successive interference cancellation (SIC) decoding and maximum likelihood (ML) decoding.

36. The Node-B of claim 35 further comprising:
a space time decoder for performing space time decoding.

37. The Node-B of claim 34 further comprising:
a channel state feedback unit for sending channel state information to the WTRU.

38. The Node-B of claim 37 wherein a limited feedback is used for channel state information feedback.

39. The Node-B of claim 38 wherein channel vector quantization (VQ) is used for channel state information feedback.

40. The Node-B of claim 37 wherein statistical feedback is used for channel state information feedback.

41. The Node-B of claim 40 wherein one of mean feedback and covariance feedback is used for channel state information feedback.
